(19) United States
(12) Patent Application Publication
(10) Pub. No.: US 2024/0055018 A1
(43) Pub. Date: Feb. 15, 2024

(54) ITERATIVE SPEECH RECOGNITION WITH SEMANTIC INTERPRETATION

(71) Applicant: Verint Americas Inc., Alpharetta, GA (US)

(72) Inventors: Michael Levy, Melville, NY (US); Jay Miller, Arvada, CO (US)

(21) Appl. No.: 17/819,354

(22) Filed: Aug. 12, 2022

(51) Int. Cl. G10L 25/93; G10L 25/78; G10L 15/26; G06F 40/30

(52) U.S. Cl. CPC G10L 25/93; G10L 25/78; G10L 15/26; G06F 40/30; G10L 2025/783

(57) ABSTRACT

An interactive voice response (IVR) system including iterative speech recognition with semantic interpretation is deployed to determine when a user is finished speaking, thus saving them time and frustration. The IVR system can repeatedly receive an audio input representing a portion of human speech, transcribe the speech into text, and determine a semantic meaning of the text. If the semantic meaning corresponds to a valid input or response to the IVR system, then the IVR system can determine that the user input is complete and respond to the user after the user is silent for a predetermined time period. If the semantic meaning does not correspond to a valid input to the IVR system, the IVR system can determine that the user input is not complete and can wait for a second predetermined time period before determining that the user has finished speaking.

### BACKGROUND

Customers can interact with computer systems using speech. Automatic speech recognizers and semantic interpreters can be used to determine the meaning of a customer's speech, which can be an input to the computer system. The computer system can determine when the user has finished speaking by waiting for a period of silence. This period of silence can be frustrating and time consuming for customers.

### SUMMARY

The present disclosure describes methods and systems for determining that an audio input is complete. An interactive voice response (IVR) system can be used to receive an audio input, for example a section of human speech from a phone call. An issue with IVR systems is determining when the user has finished speaking. For example, a IVR system can be configured to wait for two seconds of silence before determining that the user is finished speaking. This can be frustrating for the user, who is required to wait for at least two seconds after each audio input.

Some speech recognition engines focus on accurately transcribing a caller's speech into text without applying semantic processing. In some cases, the speech recognition engines cannot differentiate between ‘complete’ or ‘incomplete’ speech—that is, whether the transcribed speech matches a well-known or expected meaning. Developers using speech recognizer engines that focus on transcription, can configure the speech recognizers to detect that a user is finished speaking. Examples of these settings include speech-complete timeout and speech incomplete timeout. If the speech recognition engine cannot differentiate between ‘complete’ and ‘incomplete’ speech, then the system may use the same value for Speech-Complete-Timeout and Speech-Incomplete-Timeout. However, when using speech recognizer engines in IVR applications, IVR developers may use different settings to avoid a less responsive experience to the caller. Without the ability to decide the completeness of a transcription, developers are forced to wait for a certain amount of silence to ensure a caller is finished speaking, resulting in frustrating delays in the user experience.

Embodiments of the present disclosure allow a speech recognition engine that focuses on transcription without semantic processing to integrate semantic processing into the recognition process and provide capabilities to improve the responsiveness of the IVR system.

Accordingly, embodiments of the present disclosure include IVR systems that can include a semantic interpreter that can determine the semantic meaning of speech while the user is still speaking. If the semantic meaning is a valid input to the IVR system, then the length of silence required for the system to determine that the user is finished speaking can be reduced. If the semantic meaning is not a valid input, then the system can wait for a longer period of silence before determining that the user has finished speaking. This allows the user to start speaking again. For example, the user may need a second to think or to take a breath. Embodiments of the present disclosure allow for IVR systems that can iteratively determine the semantic meaning of the user's speech while the user is speaking in order to determine whether the user has expressed a valid input to the system. Additionally, embodiments of the present disclosure can be used when the IVR includes a separate speech recognizer module and a separate semantic interpreter module and can aggregate the results of multiple speech recognizer and semantic interpreter modules. In accordance with the present disclosure, a method of determining that a user is finished speaking is described, where the method includes receiving an audio input at a speech recognizer component, where the audio input includes a section of human speech; transcribing the audio input into a string of text using the speech recognizer component; determining, by a semantic interpreter component, a semantic meaning of the string of text; determining, by the semantic interpreter component, whether the semantic meaning of the string of text is a semantic match by comparing the semantic meaning of the string of text to a set of known valid responses; and iteratively repeating the method until it is determined there is the semantic match and stopping receiving the audio input.

In accordance with another aspect of the present disclosure, a computer system for determining that an audio input is complete is described, where the computer system includes: a processor and; a memory operably coupled to the processor, the memory having computer-executable instructions stored thereon that, when executed by the processor, cause the processor to: receive an audio input, where the audio input includes a section of human speech; transcribe the audio input into a string of text; determine a semantic meaning of the string of text; determine whether the semantic meaning of the string of text is a semantic match by comparing the semantic meaning of the string of text to a set of known valid responses; and iteratively repeat the instructions until it is determined there is the semantic match and stopping receiving the audio input.

In accordance with yet another aspect of the present disclosure, a system for determining that an audio input is complete is described, where the system includes a speech recognizer module configured to transcribe an audio input into a string of text; a semantic interpreter module configured to determine a semantic meaning of the string of text; a semantic match module configured to determine whether the semantic meaning of the string of text is a semantic match, and to determine that the audio input is complete based on whether the semantic meaning of the string of text is a semantic match.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1A illustrates a speech recognizer and semantic interpreter that can be used to determine semantic meaning in an example embodiment of the present disclosure.

FIG. 1B illustrates a system with a speech recognizer configured to output multiple candidate phrases, according to an example embodiment of the present disclosure.

FIG. 1C illustrates a system with two speech recognizers and a merge and sort module configured to merge and sort the outputs from the semantic interpreter, according to an example embodiment of the present disclosure.

FIG. 1D illustrates a system for using multiple semantic interpreters that can be used with any of the example embodiments illustrated in FIGS. 1A-1C.

FIG. 2 illustrates an example flow diagram of operations performed to determine when a semantic match exists and a user has completed speaking.

FIG. 3 illustrates an example audio input waveform.

FIG. 4 illustrates a table of speech transcriptions and semantic results for the audio input waveform illustrated in FIG. 3.

FIG. 5 illustrates example computing systems that may be utilized according to certain embodiments.

### DETAILED DESCRIPTION

Overview

The present disclosure is directed to a system that receives human speech, determines the meaning of that speech, and determines when the user is finished speaking. As an example, the system can be used as part of a call center, where the human speech is speech from a customer speaking into a telephone.

The system can include a sub-system for transcribing the speech into text, referred to herein as a “speech recognizer.” For example, the speech recognizer can receive an audio file or audio stream from the customer and transcribe that audio stream into text in real time. The speech recognizer can also identify ambiguities in the transcription and output multiple transcriptions, and each transcription can be associated with a confidence value that represents the likelihood that the transcription is correct.

The system can also include a subsystem for determining the meaning of the text that was transcribed by the speech recognizer, referred to herein as a “semantic interpreter.” As an example, the semantic interpreter can determine the logical meaning of a string of text produced by the speech recognizer. Continuing with the example, if the speech recognizer transcribes the text as “sure” or “alright” or “yes”, the semantic interpreter can determine that all three sections of text mean substantially the same thing—that the user is agreeing. The output of the semantic interpreter can be checked by the system to determine if it corresponds to a valid input to the system. For example, “sure” can be a valid response to a prompt requesting the user's permission to send a text message, but “sure” can be an invalid response to a prompt requesting that the user state their account number.

The system can further determine when the user is finished speaking by iteratively processing the user speech over time. The sub-system can, in real time, receive the user's speech and process it using the speech recognizer and semantic interpreter. For example, after the user has spoken for 0.5 seconds, the first 0.5 seconds of the user's speech can be input to the speech recognizer, and then to the semantic interpreter, and the system can determine whether the output of the semantic interpreter is a valid response. When the user has spoken for 1 second, the system can then take the first 1 second of the user's speech and input it into the speech recognizer and semantic interpreter. The system can generate a confidence value for whether the first 0.5 seconds or first 1 second correspond to valid inputs. When a valid input is detected, and a specified confidence value is reached, the system can determine that the user has finished speaking.

Optionally, the system can use more than one speech recognizer and semantic interpreter in parallel and integrate the results of each to determine when the user has finished speaking.

### Example Environment and Processes

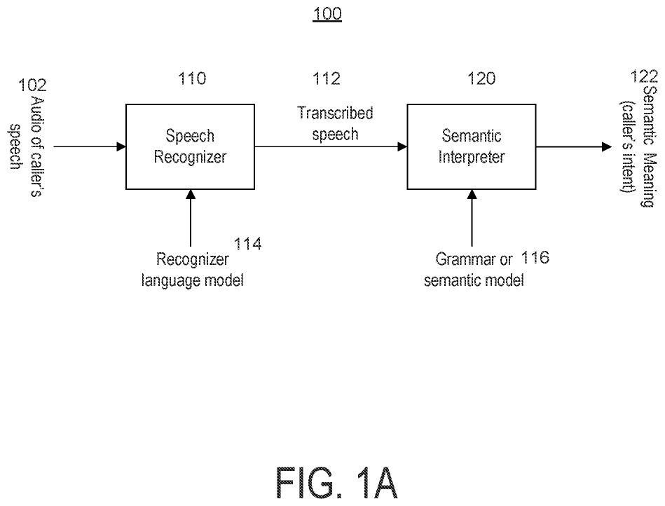

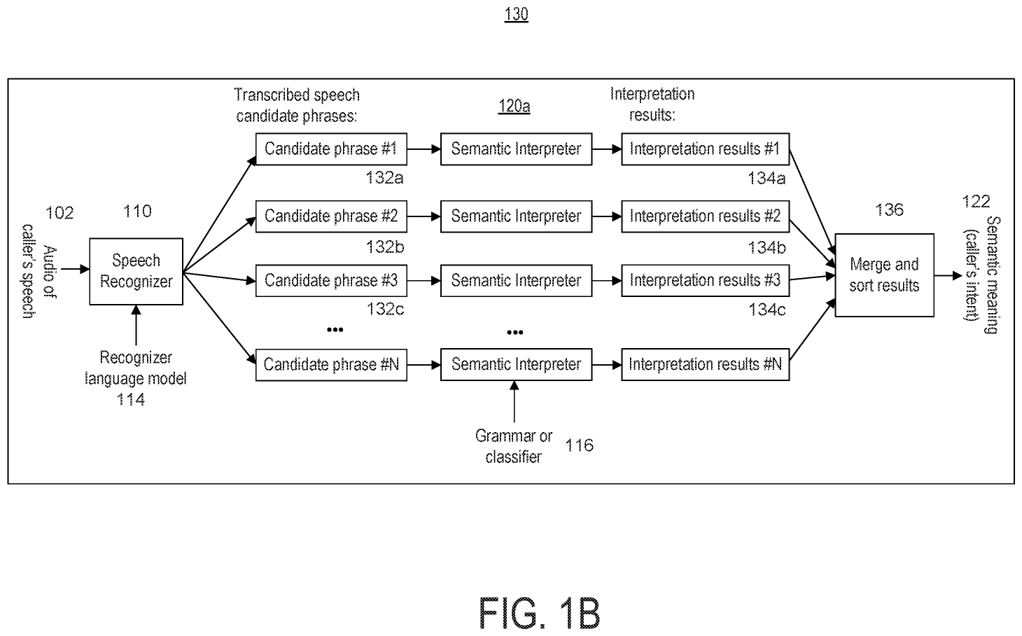

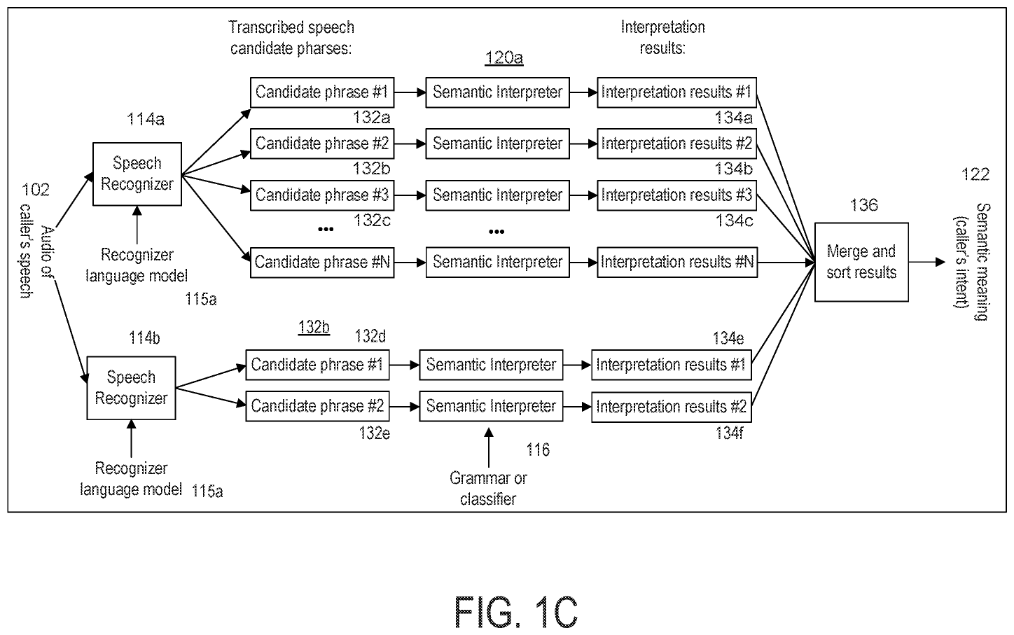

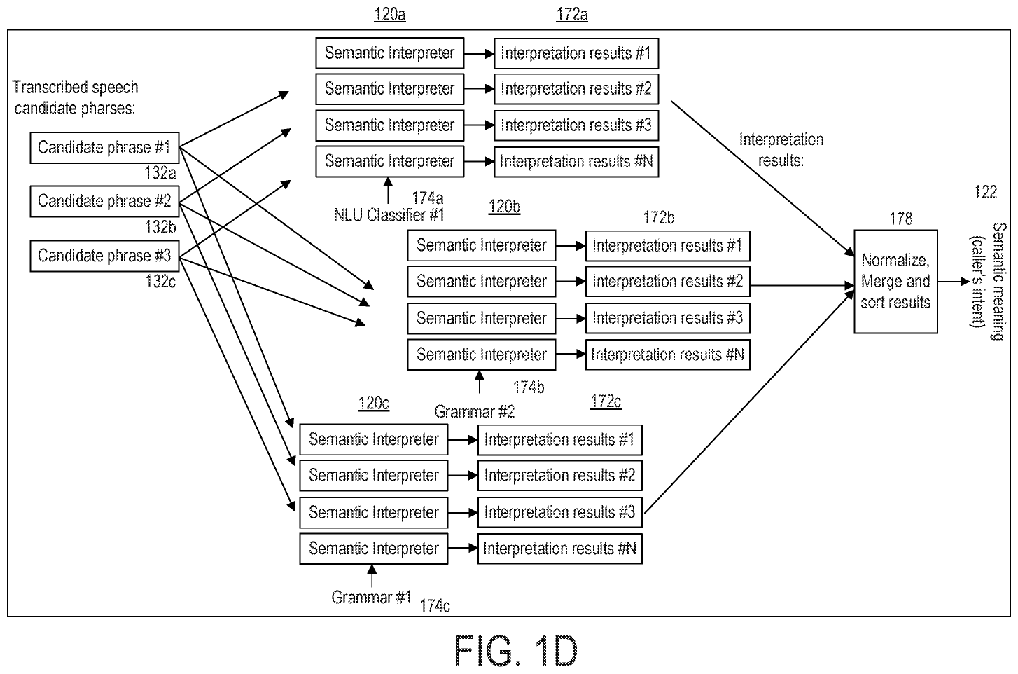

FIGS. 1A-1D illustrate example overview schematics of systems that implement iterative speech recognition including semantic interpretation in accordance with the present disclosure.

With reference to FIG. 1A, the present disclosure includes a system 100 for analyzing an audio input 102. The system 100 can include a speech recognizer 110 that can use a recognizer language model 114 to create a transcribed speech output 112. The speech recognizer 110 can also be referred to as an “automatic speech recognizer” or “ASR.” ASR's can be used in telephony applications including like interactive voice response (IVR) systems. IVR systems can include both an ASR component and a component for determining the semantic meaning of the recognized speech. IVR systems can also identify if a semantic match has occurred while collecting and recognizing speech audio from the caller.

IVR systems can be configured using timeout values to determine when a user is finished speaking. Two examples of timeout values that are used are “speech complete timeout” and “speech incomplete timeout.” Non-limiting examples of these timeout values can range from 0 to 5000 ms. As described herein, in some embodiments of the present disclosure the “speech complete timeout” is different than the “speech incomplete timeout.” Additional non-limiting examples for the speech complete timeout are 0-500 ms and additional non-limiting examples for the speech incomplete timeout are 2000-5000 ms. It should be understood that both the speech incomplete timeout and speech complete timeout can be adjusted based on the likelihood of speech pauses in different applications. The timeout values can represent that amount of silence required following user speech for the speech recognizer 110 to finalize the result.

The speech complete timeout value can be used when the system recognizes the speech and it is a valid input (for example, a semantic match) and the speech incomplete timeout can be used when the system does not recognize the speech, or the speech is not a valid input.

The Speech-Complete-Timeout may be set to a time that is shorter than Speech-Incomplete-Timeout. This can allow the IVR to be more responsive when a caller has said a complete phrase (the shorter Speech-Complete-Timeout allows the ASR to more quickly respond when the caller has said a complete phrase), but the ASR can wait longer if the caller has not completed a phrase that leads to a semantic match (the longer Speech-Incomplete-Timeout gives the caller time to pause and then keep speaking).

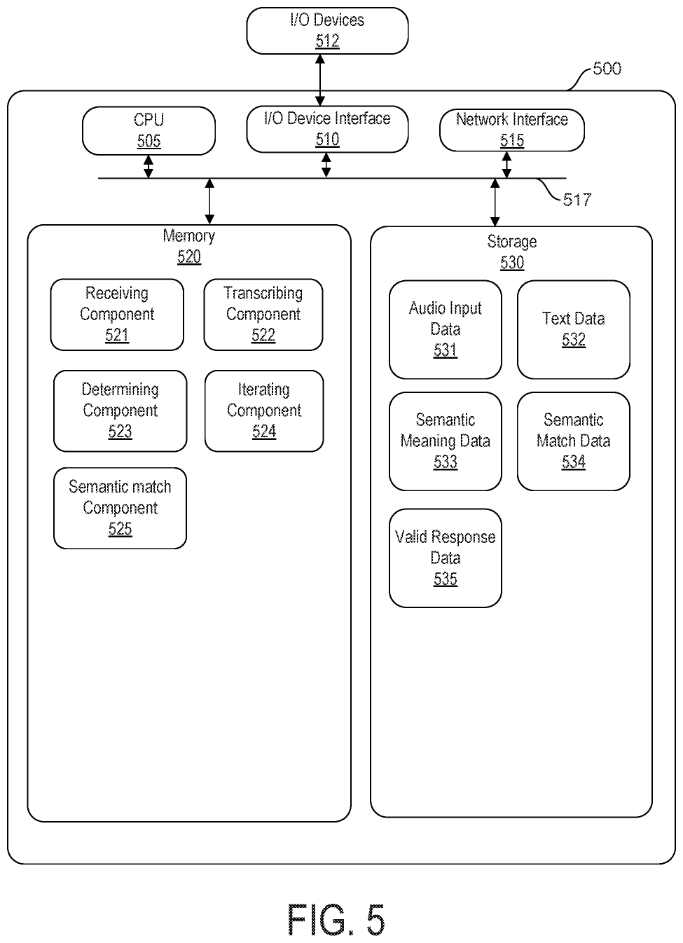

The speech recognizer 110 can be implemented by a processor and memory (for example, as a program stored on a computer readable medium), as described below with reference to FIG. 5. The speech recognizer 110 can also be implemented using program that is configured to receive audio input 102 and produce text transcription, referred to herein as a “speech recognition engine.” Again, the speech recognition engine that can be used to implement the speech recognizer can be implemented using a processor and memory (for example, a computer readable medium). In some embodiments, the speech recognizer or recognition engine can be a cloud service. Additionally, in some embodiments, the speech recognizer can be implemented a local server or servers, or on an individual computer.

Embodiments of the present disclosure can use speech recognizers 110 and speech recognition engines that are not capable of interpreting the meaning or intent of the speech in the audio input 102. When the speech recognizer 110 or speech recognition engine is not capable of determining a semantic meaning of the audio input 102, the speech recognizer 110 cannot determine whether the audio input 102 is a semantic match. Therefore, the speech recognizer may not use a “speech complete timeout” because the speech recognizer may not be able to determine whether the speech is complete. This can lead to a less responsive user experience.

The transcribed speech output 112 can be the input to a semantic interpreter 120 that can use a grammar or semantic model 116 to determine a semantic meaning 122 of the audio input 102. In some embodiments, the semantic interpreter 120 can process standard IVR rules-based grammars (for example, SRGS+XML), statistical classifiers, call a cloud or web service for NLU processing, and/or any other method or combination of methods for extracting meaning from transcribed text. As a non-limiting example, a grammar can represent a rule or pattern that can be used to determine the meaning of text (for example, the transcribed speech output). As a non-limiting example, a grammar can include a rule that recognizes five-digit strings of numbers as United States Postal zip codes. Another non-limiting example of a grammar can interpret the location of an airport (for example, “Boston,” “New York” or “Chicago”) as corresponding to the respective airport's three-letter identifier (for example, BOS, JFK, ORD).

Embodiments of the present disclosure can continuously process the audio input 102 including a caller's speech while the audio is being recorded (for example, when a caller is speaking). As such, the operations described with reference to FIG. 1A can be repeated at predetermined intervals during the recording of the audio. For example, the system 100 can process a first section of audio input 102 that corresponds to 0.5 seconds of speech after 0.5 seconds of audio have been recorded. The system 100 can repeat the process again for the first 1 second of speech, and again at 1.5 seconds, and so on. This process of repeatedly determining the semantic meaning 122 while audio is being captured can be referred to as iteratively performing speech recognition.

The system 100 can determine whether the semantic meaning 122 corresponds to a valid input into the system, and in some embodiments of the present disclosure, the system 100 can stop recording audio input 102 when it determines the semantic meaning corresponds to a valid input to the system (for example, is a semantic match). Alternatively or additionally, the system 100 can implement rules for determining when to stop recording audio input 102 based on the semantic meaning 122 and/or by measuring a period of silence in the audio input 102. The rules can include rules referred to herein as “Speech Complete Timeout” and/or “Speech Incomplete Timeout.” A “speech complete timeout” rule causes the system to stop recording audio when the semantic meaning 122 is a valid semantic meaning, and the period of silence in the audio input 102 matches a certain threshold. A “speech incomplete timeout” causes the system to stop recording audio when the semantic meaning is an invalid semantic meaning, and the period of silence matches or exceeds a certain threshold.

In some embodiments of the present disclosure, the system 100 can iteratively determine the semantic meaning 122 of the audio input 102 before the user has finished speaking. Based on the semantic meaning 122, the system can determine whether a semantic match has occurred, and, if so, the system can be configured to respond to the user after a short period of silence (for example, a short “speech complete timeout”). This allows the system to be more responsive.

In embodiments of the present disclosure that do not include iterative processing, the audio collection can require a longer period of silence to determine that the user is finished speaking, which can reduce the responsiveness of the system.

With reference to FIG. 1B, in certain embodiments of the present disclosure, the speech recognizer 110 can output multiple candidate phrases 132a, 132b, 132c, as shown in the system 130. The candidate phrases 132a, 132b, 132c can each correspond to a possible text transcription of the same audio input 102. The candidate phrases 132a, 132b, 132c can be each associated with a speech recognition confidence value generated by the speech recognizer 110. Each candidate phrase 132a, 132b, 132c can be an input into the semantic interpreter 120, which can then produce semantic interpretation results 134a, 134b, 134c corresponding to each of the candidate phrases 132a, 132b, 132c produced by the speech recognizer. The semantic interpretation results 134a, 134b, 134c can each include a semantic interpretation confidence value. The interpretation results 134a, 134b, 134c can be merged and sorted by a merging/sorting module 136, which can then output a semantic meaning 122. The merging/sorting module can receive the confidence value associated with each semantic interpretation 134a, 134b, 134c and each of the candidate phrases 132a, 132b, 132c, and combine the confidence values to produce an overall confidence value for each of the interpretation results 134a, 134b, 134c. The merging/sorting module 136 can also determine whether each of the semantic interpretation results 134a, 134b, 134c is a semantic match. Based on the overall confidence value for each interpretation result, and whether each interpretation result is a semantic match, the merging/sorting module 136 can select the semantic interpretation result 134a, 134b, 134c and output the semantic meaning 122.

Still with reference to FIG. 1B, speech recognizers 110 can return a set of candidate transcriptions or candidate phrases 132a, 132b, 132c. Without semantic interpretation, it can be difficult to rank the candidate phrases 132a, 132b, 132c and select the best possible match. Embodiments of the present disclosure can allow semantic interpretation to be performed repeatedly on multiple or all available candidate phrases 132a, 132b, 132c. At each iteration, semantic interpretation can be performed on each candidate phrase 132a, 132b, 132c by the semantic interpreter(s) 120.

With reference to FIG. 1C, certain embodiments of the present disclosure can be configured to merge/sort results from multiple speech recognizers 114a, 114b. The speech recognizers 114a 114b can each output a set of corresponding candidate phrases. The speech recognizer 114a outputs the candidate phrases 132a, 132b, 132c, and the speech recognizer 114b outputs the candidate phrases 132d, 132e. The candidate phrases 132a, 132b, 132c, 132d, 132e can be input into the semantic interpreter 120a. The semantic interpreter 120a can output interpretation results 134a, 134b, 134c, 134d, 134e, corresponding to the candidate phrases 132a, 132b, 132c, 132d, 132e. The interpretation results 134a, 134b, 134c, 134d, 134e can be then sorted and merged in the merging/sorting module 136, as described with reference to FIG. 1B. It should be understood that the two speech recognizers 114a, 114b and their outputs (candidate phrases 132a, 132b, 132c, 132d, 132e) are intended only as non-limiting examples, and that any number of speech recognizers 114a, 114b can be used in embodiments of the present disclosure to generate any number of candidate phrases. The merge and sort module 136 can be configured to normalize the speech recognition confidence values and candidate phrases 132a, 132b, 132c, 132d, 132e that are output by the speech recognizers 114a, 114b so that the interpretation results 134a, 134b, 134c, 134d, 134e for each speech recognizer 114a, 114b can be compared and ranked.

As a non-limiting example, a user speech input is processed by the speech recognizer, which outputs three possible alternative text strings: “I need to speak to an operator” “I need to see an offer” “I feel like seeing an opera.” The speech recognizer assigns each text string a speech recognition confidence value, so the first text string is assigned a speech recognition confidence value of 0.91, the second is assigned a speech a speech recognition confidence value of 0.33 and the third text string is assigned a speech recognition confidence value of 0.04. Each of these three text strings are input into a semantic interpreter, which determines a meaning of the user's speech. The first text string, including “operator” is interpreted to mean that the user is requesting to speak to an agent, and this semantic interpretation is assigned a confidence value of 0.92. The second text string, with “offer” is interpreted as a request to speak to current sale, with a semantic interpretation confidence value of 0.94. Finally, the string including “opera” is interpreted as not corresponding to a valid response, with a confidence value of 0.44.

Based on the three text strings of the present example, the confidence values for the semantic interpretation and speech interpretation can be combined (for example by a merge and sort module) to produce a combined score that represents the overall confidence that the input has been both correctly recognized and interpreted. In the non-limiting example, the string “I need to speak to an operator” is given a combined score of 0.84, the string “I need to see an offer” is given a combined score of 0.31, and the string “I feel like seeing an opera” is given a combined score of 0.02. Higher confidence values represent greater confidence in the present example, so that the first string and corresponding interpretation of that string can be selected by the system (for example, by the merge and sort module) as the most likely user input, and the third string as the least likely user input.

With reference to FIG. 1D, certain embodiments of the present disclosure can include applying multiple semantic interpreters 120a, 120b, 120c to the same set of candidate phrases 132. So, as an example, the semantic interpreter 120a described with reference to FIGS. 1A-1C can be used with additional semantic interpreters 120b, 120c. In some embodiments, the semantic interpreters 120a, 120b, 120c can be different semantic interpreters that each implement a different classifier. As shown in FIG. 1D, the first semantic interpreter 120a can implement an NLU classifier 174a, the third semantic interpreter 120c can implement a first grammar classifier 174c, and the second semantic interpreter 120b can implement a second grammar classifier 174b. Each of the semantic interpreters 120a, 120b, 120c can output semantic interpretation results 172a, 172b, 172c for each of the candidate phrases 132a, 132b, 132c. As shown in FIG. 1D, the interpretation results can be normalized, merged and sorted by the normalize, merge and sort module 178. Normalization, as described herein, refers to the process of rescaling the semantic interpretation confidence values and interpretation results so that the results can be compared. As a non-limiting example, the normalize merge and sort module 178 can store statistical information about each of the semantic interpreters and normalize the semantic interpretation results based on the statistical information. This can include information about the median or mean confidence values produced by the semantic interpreters. This approach can be extended such that each candidate phrase 132a, 132b, 132c is processed by a set of semantic interpreters 170a, 170b, 170c (also referred to as semantic processors). The results of semantic interpretation of all candidate phrases can be normalized, merged, and sorted based on overall confidence score to find the best matching result and to determine if a match has been found.

It should be understood that the architecture for applying different semantic interpreters 170a, 170b, 170c to the same set of candidate phrases described with reference to FIG. 1D can be used in the embodiments illustrated in FIGS. 1B, and 1C.

In accordance with certain embodiments, one or more of the components of FIGS. 1A-1D may be implemented using cloud services to process audio inputs, perform semantic interpretation, and other processes described above. For example, the components shown in FIGS. 1A-1D may be in the same or different cloud service environments and may communicate with each other over one or more network connections, such as, a LAN, WAN, Internet or other network connectivity. In such embodiments, speech recognizer 110 can be implemented within a cloud services environment to receive an audio input 102. Responsive or subsequent to transcribing the speech, the speech recognizer 110 provides the transcribed speech output 112 to the semantic interpreter 120, implemented in the same or different cloud services environment, over the network connection to generate the semantic meaning 122. The semantic interpreter 120 may determine a semantic interpretation confidence value associated with the semantic meaning 122. An example semantic interpretation confidence value can be a value representing the likelihood that the semantic interpreter 120 output is correct, as discussed in more detail herein. The semantic meaning 122 received from the cloud service client can be processed, and the semantic meaning 122 can be determined and output. It should be understood that embodiments of the present disclosure using cloud services can use any number of cloud-based components or non-cloud-based components to perform the processes described herein.

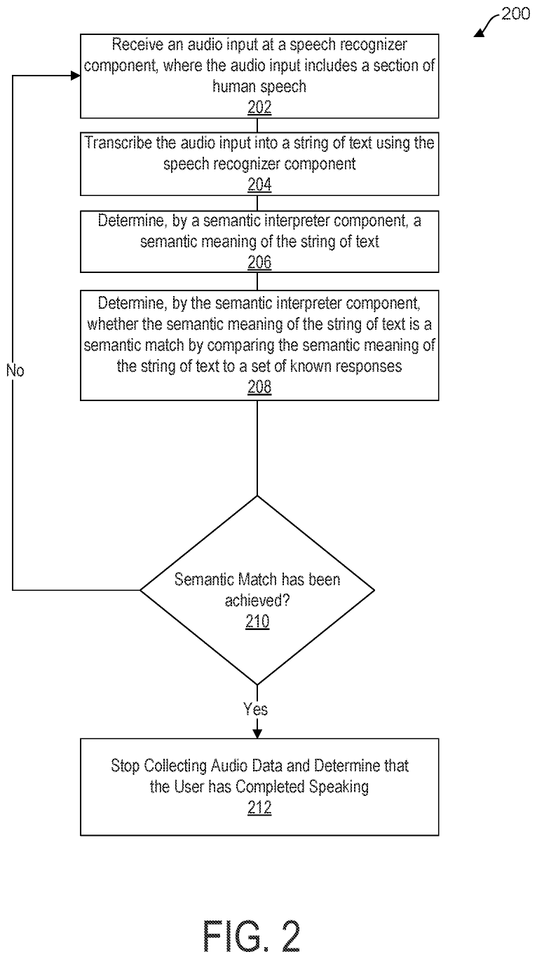

With reference to FIG. 2, certain embodiments of the present disclosure include methods for determining whether a semantic match exists and whether to stop collecting audio data. The method illustrated in FIG. 2 can be implemented using some or all of the components illustrated with reference to FIGS. 1A-1D.

At block 202, the speech recognizer 110 receives the audio input 102. As described with reference to FIG. 1C, the speech recognizer 110 can be one or more speech recognizers 114a, 114b, and the one or more speech recognizers 114a, 114b can perform speech recognition based on the same or different speech recognizer language models 115a, 115b.

At block 204, the speech recognizer 110 outputs a transcript of the recognized speech of the audio data. In some embodiments, the speech recognizer 110 can also output a speech recognition confidence value associated with the transcript, as described with reference to FIGS. 1A-1D.

At block 206, the transcribed speech output 112 is input into a semantic interpreter 120. As described with reference to FIGS. 1A-1D, the semantic interpreter 120 can be one or more semantic interpreters 120a, 120b, 120c and the semantic interpreters 120a, 120b, 120c can include different types of semantic interpreters 120a, 120b, 120c.

At block 208, the semantic interpreter 120 outputs a semantic meaning of the audio data. As described with reference to the semantic interpreters 120a, 120b, 120c illustrated in FIGS. 1A-1D, the semantic interpreters 120a, 120b, 120c can also output semantic interpretation confidence values that represent the likelihood that the semantic interpreter 120 output is correct.

At block 210, whether a semantic match exists is determined by the merge and sort component based on the information output at block 208 by the semantic interpreters. As a non-limiting example, whether a semantic match exists can be determined by comparing the output from block 208 to a set of known valid responses or inputs to the system (for example, the system 100 illustrated in FIG. 1A, or the system 130 illustrated in FIG. 1B). Continuing with the example, the system can be configured to only accept certain types of user inputs, and the output of block 208 can be compared to the set of valid user inputs to see if it matches any of the valid user inputs. If a match is found, then a semantic match can be identified.

At block 210, it is determined if collecting audio data should be stopped or to iteratively repeat the process by collecting additional audio data. This can be based on whether a semantic match is determined at block 208. In some embodiments, the determining a block 210 may not be based on whether a semantic match is determined at block 208. Alternatively or additionally, the determining at block 210 can be based on the semantic interpretation confidence values and/or the speech recognition confidence values.

If, at block 210, the determination is to continue collecting audio data, embodiments of the present disclosure can repeat the steps of the method 200. For example, the method can include delaying for a predetermined interval, for example, a half second. After the interval, the system can receive audio data including the audio data recorded after the audio data was received at block 202. The method can then include iteratively repeating the operations of blocks 204, 206 and 208 based on the additional audio data. Again, at block 210, the system can determine whether a semantic match exists. If the semantic match exists, the method can proceed to block 212.

At block 212, the collection of audio data stops, and it is determined if the user has completed speaking. Optionally or additionally, an action may be taken to respond to the user input. Additionally, a further action may be taken based on the semantic match, for example completing an operation that corresponds to the semantic meaning determined by the semantic interpreter at block 208. Optionally, block 212 can include waiting for the user to be silent for a predetermined period of time, for example, the “speech complete timeout” described herein. Since the speech complete timeout can be a relatively short period of time, responding after the speech complete timeout can provide the user with a responsive experience. As shown in FIG. 2, the present disclosure contemplates that the steps of method 200 can be performed repeatedly or iteratively any number of times as the audio data is recorded.

### Example

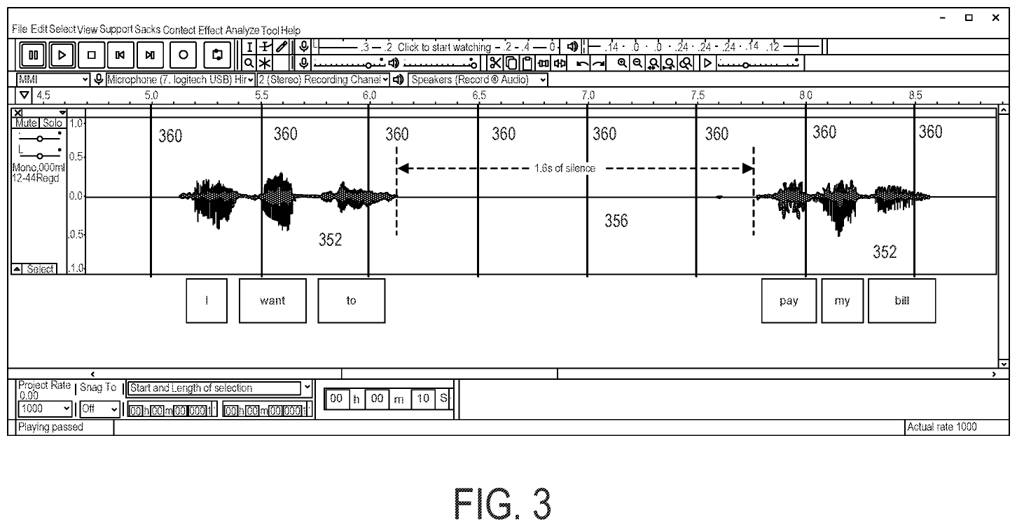

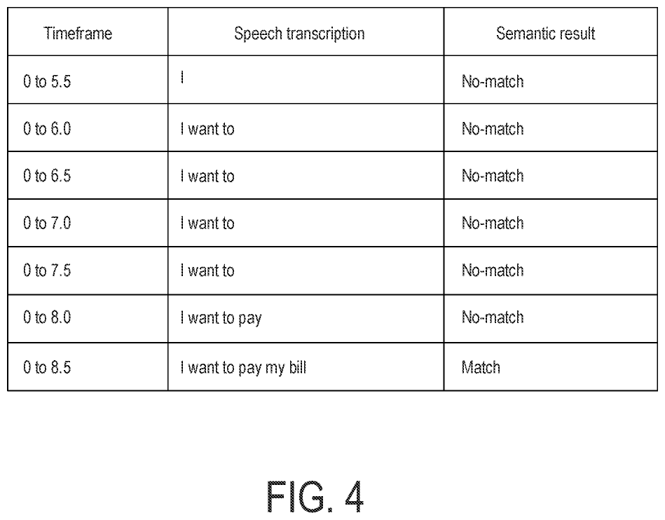

With reference to FIGS. 3 and 4, an illustration of example audio data (for example, the audio data received at block 202 of FIG. 2) is shown. In this non-limiting example, the system (for example, the system 100 illustrated in FIG. 1A, the system 130 illustrated in FIG. 1B) is an automated phone payment system, and the system is configured to identify the phrase “pay my bill” as a semantic match that can cause the system to initiate bill paying operations.

FIG. 3 shows an example of an audio waveform 352 for a caller that spoke the phrase “I want to pay my bill.” However, as shown in FIG. 3, the caller paused during their speech and actually said “I want to (pause) pay my bill.” If the audio is analyzed by waiting for a pause, and then processing the audio, then the pause 356 of 1.6 seconds can cause the recording to stop after the caller says, “I want to.” If the input “I want to” is not a semantic match, then the system will be unable to effectively respond to the user input.

However, embodiments of the present disclosure, including the systems 100, 130 of FIGS. 1A-1D and the method 200 illustrated in FIG. 2, can be configured to not stop recording at the pause 356. Embodiments of the present disclosure can be configured to continuously process the audio input into the speech recognizer 110 (for example, the audio waveform 352) and stop recording only when a semantic match has been recognized, or when no semantic match has been recognized, and a long pause has occurred. Lines 360 in FIG. 3 illustrate 0.5 second intervals during the recording where the example system has received additional audio data and performed semantic interpretation. So, if the phrase “I want to” is not a semantic match, the system can be configured to continue recording audio during the 1.6 second pause 356. Then, when the audio input “pay my bill” is received, the semantic interpreter can determine that the audio input “I want to pay my bill” is a semantic match.

FIG. 4 illustrates a table showing an example of the speech transcription output and semantic match output for the timeframes of 0 to 5.5 through 0 to 8.5 seconds, for the example shown in FIG. 3. As shown in the example, the system (for example, the system 100 illustrated in FIG. 1A, or the system 130 illustrated in FIG. 1B) performs another iteration of the method illustrated in FIG. 2 every 0.5 seconds and continues until a semantic match is determined when the user completes the phrase “I want to pay my bill.” This complete phrase can be transcribed by the speech recognizer and the text transcription processed by a semantic processor. The result will be a semantic match and the application will know the caller's intent was to pay their bill.

By determining the semantic match while the caller is speaking, the responsiveness of the systems is improved. Specifically, the implementation described with reference to FIGS. 3 and 4 can allow the system to be configured with a speech complete timeout value that is shorter than the speech incomplete timeout. The systems 100, 130 and method 200 described with reference to FIGS. 1A-4 can implement a speech incomplete timeout without requiring that the speech recognizer 110 be capable of determining the semantic meaning of the audio input 102 that is recognized.

### Example Improvements of the Embodiments of the Present Disclosure

As noted above, conventional systems may not be able to distinguish between a semantic match and a semantic no-match. As a result, the Speech-Complete-Timeout is set to a time value equal to Speech-Incomplete-Timeout. With reference to FIG. 3, an example input illustrates this problem and provides a visual understanding of the improvements provided of the embodiments of the present disclosure:

(1) If Speech-Complete-Timeout is set equal to Speech-Incomplete-Timeout=1 s, the conventional system will be responsive. It will recognize the caller's input after only 1 s of silence. However, in this case, the recognition would complete after a partial utterance where the caller had only said “I want to”. This would return a no-match result. In this case, the system is responsive, but does not give a good result. In this case, the system would return a result at around 7.1 s, which is 1 s of silence detected.

(2) If Speech-Complete-Timeout is set equal Speech-Incomplete-Timeout=3 s, the conventional system will be sluggish. The conventional system can recognize the caller's input after 3 s of silence. In this case the conventional system will wait for the caller to complete their utterance and the system will properly recognize the correct meaning of the utterance. However, the caller will have to wait for 3 s after they complete their utterance for the conventional system to process this result. In this case, the system would return a result at around 11.6 s, which is 3 s of silence after the match is found.

Thus, without iteratively determining whether a semantic match has occurred in accordance with the embodiments of the present disclosure, the conventional system can be forced to trade responsiveness for accuracy. For example, if the conventional system described with reference to FIGS. 3 and 4 had a timeout value of 1 second, then the conventional system would have timed out without receiving a valid response in the example illustrated in FIG. 3. On the other hand, if the conventional system had a timeout value of 2 seconds (to avoid timing out during pause 356) then the conventional system would be less responsive because the user would have to wait 2 seconds after every input. It is now understood that embodiments of the present disclosure provide for the system to be configured to have a shorter timeout period when a semantic match is detected, and a longer timeout period when no semantic match is detected.

As shown with the lines 360 in FIG. 3, embodiments of the present disclosure can perform full speech recognition and semantic process every half second. This enables timeouts to be set such that Speech-Complete-Timeout is less than Speech-Incomplete-Timeout. Embodiments of the present disclosure can also be configured to receive audio inputs 102 more frequently or less frequently than 0.5 seconds.

Still with reference to FIG. 3, if the system is configured so that Speech-Complete-Timeout is equal 1 s and Speech-Incomplete-Timeout is equal to 3 s, the system will be responsive, and it will correctly recognize the caller's input after only 1 s of silence. With these timeouts embodiments of the system disclosed herein can repeatedly process the input audio from the caller. At every interval, the system can determine if the current input represents a match or a no-match. Since the system continuously tracks the current state of the semantic result, it can apply the timers accordingly. In this example, Speech-Incomplete-Timeout is applied when the current input is not yet a semantic match. This gives the ASR more time to continue gathering input audio from the caller, and speech-Complete-Timeout is applied when the current input is a semantic match. This can allow the ASR to be more responsive and more quickly respond to the user if their input represents a semantic match.

Still with reference to FIG. 3, the example embodiment of the present disclosure can return a result at around 9.6 s, which is 1 s of silence after the match is found. The ASR would successfully wait passed the pause to gather more caller speech.

FIG. 5 illustrates an example of a computer system 500 that may include the kinds of software programs, data stores, and hardware according to certain embodiments. As shown, the computing system 500 includes, without limitation, a central processing unit (CPU) 505, a network interface 515, a memory 520, and storage 530, each connected to a bus 517. The computing system 500 may also include an I/O device interface 510 connecting I/O devices 612 (for example, keyboard, display, and mouse devices) to the computing system 500. Further, the computing elements shown in computing system 500 may correspond to a physical computing system (for example, a system in a data center) or may be a virtual computing instance executing within a computing cloud.

The CPU 505 retrieves and executes programming instructions stored in memory 520 as well as stored in the storage 530. The bus 517 is used to transmit programming instructions and application data between the CPU 505, I/O device interface 510, storage 530, network interface 515, and memory 520. Note, CPU 505 is included to be representative of a single CPU, multiple CPUs, a single CPU having multiple processing cores, and the like, and the memory 520 is generally included to be representative of random-access memory. The storage 530 may be a disk drive or flash storage device. Although shown as a single unit, the storage 530 may be a combination of fixed and/or removable storage devices, such as fixed disc drives, removable memory cards, optical storage, network-attached storage (NAS), or a storage area network (SAN).

Illustratively, the memory 520 includes a receiving component 521, a transcribing component 522, a determining component 523, an iterating component 524, and a semantic match component 525, all of which are discussed in greater detail above.

Further, the storage 530 includes the audio input data 531, text data 532, semantic meaning data 533, semantic match data 534, and valid response data 535, all of which are also discussed in greater detail above.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (for example, instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although certain implementations may refer to utilizing aspects of the presently disclosed subject matter in the context of one or more stand-alone computer systems, the subject matter is not so limited but rather may be implemented in connection with any computing environment. For example, the components described herein can be hardware and/or software components in a single or distributed systems, or in a virtual equivalent, such as, a cloud computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Thus, the system 100 and implementations therein described in the present disclosure allow a telephone system using a speech recognizer that does not perform semantic interpretation to responsively and accurately respond to user inputs.

What is claimed:

1. A method of determining that a user has completed speaking, comprising:
receiving an audio input at a speech recognizer component, wherein the audio input includes a section of human speech;
transcribing the audio input into a string of text using the speech recognizer component;
determining, by a semantic interpreter component, a semantic meaning of the string of text;
determining, by the semantic interpreter component, whether the semantic meaning of the string of text is a semantic match by comparing the semantic meaning of the string of text to a set of known valid responses;
iteratively repeating the method until it is determined there is the semantic match and stopping the receiving of the audio input; and
determining, responsive to the semantic match, that the user has completed speaking.

2. The method of claim 1, wherein the method further comprises determining a semantic interpretation confidence value, wherein the semantic interpretation confidence value represents a likelihood that the semantic interpretation is correct.

3. The method of claim 1, wherein the method further comprises determining a speech recognition confidence value, wherein the speech recognition confidence value represents a likelihood that the string of text is a correct transcription of the audio input.

4. The method of claim 1, wherein transcribing the audio input comprises transcribing the audio input into a plurality of strings of text, wherein each of the plurality of strings of text is associated with a speech recognition confidence value.

5. The method of claim 4, wherein determining the semantic match comprises determining the semantic meaning of each of the plurality of strings of text.

6. The method of claim 2, wherein determining that the audio input is complete further comprises merging and sorting semantic meanings based on the semantic interpretation confidence value.

7. The method of claim 1, wherein stopping receiving the audio input comprises:
detecting a period of silence in the audio input; comparing a length of the period of silence to a predetermined timeout period; and,
when the length of the period of silence is greater than the predetermined timeout period, stopping receiving the audio input.

8. A computer system, comprising:
a memory operably coupled to the processor, the memory having computer-executable instructions stored thereon;
a processor configured to execute the computer-executable instructions and cause the computer system to perform a method of determining that an audio input is complete, the computer-executable instructions when executed by the processor causes the computer system to:
receive the audio input, wherein the audio input includes a section of human speech;
transcribe the audio input into a string of text;
determine a semantic meaning of the string of text;
determine whether the semantic meaning of the string of text is a semantic match by comparing the semantic meaning of the string of text to a set of known valid responses; and
iteratively repeat the instructions until it is determined there is the semantic match and stopping receiving the audio input; and
determining, responsive to the semantic match, that audio input is complete.

9. The computer system of claim 8, further comprising instructions to determine a semantic interpretation confidence value, wherein the semantic interpretation confidence value represents a likelihood that the semantic interpretation is correct.

10. The computer system of claim 8, further comprising instructions to determine a speech recognition confidence value, wherein the speech recognition confidence value represents a likelihood that the string of text is a correct transcription of the audio input.

11. The computer system of claim 8, further comprising instructions to transcribe the audio input into a plurality of strings of text, wherein each of the plurality of strings of text is associated with a speech recognition confidence value.

12. The computer system of claim 11, further comprising instructions to determine the semantic meaning of each of the plurality of strings of text.

13. The computer system of claim 9, further comprising instructions to merge and sort semantic meanings based on the semantic interpretation confidence value.

14. The computer system of claim 8, further comprising instructions to:
detect a period of silence in the audio input;
compare a length of the period of silence to a predetermined timeout period; and
when the length of the period of silence is greater than the predetermined timeout period, stop receiving the audio input.

15. A non-transitory computer readable medium comprising instructions that, when executed by a processor of a processing system, cause the processing system to perform a method of determining that an audio input is complete, comprising instructions to:
receive an audio input at a speech recognizer component, wherein the audio input includes a section of human speech;
transcribe the audio input into a string of text using the speech recognizer component;
determine, by a semantic interpreter component, a semantic meaning of the string of text;
determine, by the semantic interpreter component, whether the semantic meaning of the string of text is a semantic match by comparing the semantic meaning of the string of text to a set of known valid responses; and
determine, by the processor, whether the audio input is complete based on whether the string of text is a semantic match by comparing the semantic meaning of the string of text to the set of known valid responses; and
iteratively repeat the instructions until it is determined there is the semantic match and stop receiving the audio input; and
determine, responsive to the semantic match, that audio input is complete.

16. The non-transitory computer readable medium of claim 15, further comprising instructions to determine a semantic interpretation confidence value, wherein the semantic interpretation confidence value represents a likelihood that the semantic interpretation is correct.

17. The non-transitory computer readable medium of claim 15, further comprising instructions to determine a speech recognition confidence value, wherein the speech recognition confidence value represents a likelihood that the string of text is a correct transcription of the audio input.

18. The non-transitory computer readable medium of claim 15, further comprising instructions to transcribe the audio input into a plurality of strings of text, wherein each string of text is associated with a speech recognition confidence value.

19. The non-transitory computer readable medium of claim 18, further comprising instructions to determine the semantic meaning of each of the plurality of strings of text.

20. The non-transitory computer readable medium of claim 16, further comprising instructions to merge and sort semantic meanings based on the semantic interpretation confidence value.
